(19) United States
(12) Patent Application Publication
(10) Pub. No.: US 2022/0408751 A1
(43) Pub. Date: Dec. 29, 2022

(54) MICROORGANISM OIL COMPOSITION ENRICHED WITH POLYUNSATURATED FATTY ACIDS

(71) Applicant: POLARIS, Quimper (FR)

(72) Inventors: Stéphanie LENNON, Quimper (FR); Lionel LARVOL, Quimper (FR); Gildas BRETON, Quimper (FR)

(73) Assignee: POLARIS, Quimper (FR)

(21) Appl. No.: 17/780,305

(22) PCT Filed: Nov. 26, 2020
(86) PCT No.: PCT/EP2020/083475

§ 371 Date: May 26, 2022

(30) Foreign Application Priority Data
Nov. 26, 2019 (FR) 1913255

(51) Int. Cl. A23D 9/013; A23D 9/04; C11B 3/14; C11C 3/00

(52) U.S. Cl. CPC A23D 9/013; A23D 9/04; C11B 3/14; C11C 3/003

(57) ABSTRACT

A microorganism oil composition, in particular of microalgae, enriched with polyunsaturated fatty acids, characterised in that it has a saturated fatty acid content of less than or equal to 40 mg/g of composition, an omega-3 polyunsaturated fatty acid content greater than or equal to 500 mg/g of composition, and in that it includes, with respect to the total quantity of monoglycerides, diglycerides, triglycerides and fatty acid ethyl esters, a quantity of triglycerides below 70%, a quantity of diglycerides of between 10 and 35%, and a quantity of monoglycerides of between 1 and 5%.

For several years now it has been recommended to enrich one's diet with polyunsaturated fatty acids because of their known beneficial role in many physiological reactions and pharmaceutical functions.

Among the polyunsaturated fatty acids of interest, there are those belonging to the omega-3 family such as eicosapentaenoic acid (EPA) and docosahexaenoic acid (DHA) and those belonging to the omega-6 family such as arachidonic acid (ARA).

DHA and EPA have been the subject of many physiological studies and at the present time the essential role thereof is known in babies, children and adults. DHA is thus known for its essential role in the development of the brain and the retina and in the preservation of cognitive functions. As for EPA, this contributes to good cardiac functioning and has anti-inflammatory properties.

The diets richest in polyunsaturated acids are of marine origin, with regular consumption of fish. However, the quantity of fish that must be consumed must be large to obtain the expected therapeutic effects.

One way of increasing the intake of polyunsaturated fatty acids is to consume food supplements or concentrates based on fish oil. These products are in the form of natural oils or oils with a high concentration of DHA or EPA in the form of triglycerides or in the form of ethyl esters.

In fish oils, the polyunsaturated fatty acids are mainly found in the form of triglycerides. The methods for concentrating DHA or EPA in fish oils initially involve the separation of the fatty acids from the glycerol by ethanolic transesterification using a chemical catalyst or by enzymatic ethanolic transesterification. In a second phase, the enrichment with DHA or EPA is implemented by molecular distillation, affording the separation of the compounds according to the molecular weight thereof.

The French patent FR 2 955 459 describes for example a method for enriching a fish oil with DHA essentially in the form of monoglycerides. The method comprises a step of enzymatic ethanolysis performed in the presence of an enzyme specifically lysing the fatty acids in position (1/3) on the glycerol. Since DHA is located mainly in position sn2, the method makes it possible to eliminate the other polyunsaturated fatty acids. The ethyl esters of fatty acids and the ethanol are eliminated during a subsequent step of distillation under vacuum.

However, in the light of the increasing demand for polyunsaturated fatty acids, fish oils can no longer serve as a single source. Furthermore, they have taste and odour characteristics that are unpleasant for many consumers, and potentially high cholesterol contents. Finally, irregularity is found in terms of production of fatty acids according to the season.

It has become necessary to identify alternatives to fish oils for producing fatty acids.

Microalgae also have high polyunsaturated fatty acid contents and therefore represent an advantageous alternative source. Some of them can produce quantities of polyunsaturated fatty acids representing up to 40 to 50% of their biomass. In addition, they have the advantage of being able to be cultivated under controlled conditions. Marine microalgae do not have the negative characteristics of odour and taste of fish oils. Also they do not produce cholesterol.

Microalgae belonging to the Thraustochytrium or Schizochytrium genus are sources rich in omega-3 long-chain polyunsaturated fatty acids. For example, the microalga Schizochytrium sp can produce between 20% and 35% docosahexaenoic acid by total weight of fatty acids (Hadley et al., 2017) (Hammond et al., 2001).

By way of illustration, the international patent application WO 2013/178936 will be mentioned, which describes a method of enriching a microalga oil belonging to the Thraustochytriales sp family with DHA in the form of ethyl esters.

Another important qualitative element of oil, apart from the amount of polyunsaturated fatty acids able to be obtained, is the saturated fatty acid content. This is because several studies have demonstrated a link between the consumption of saturated fatty acids and the risks of cardiovascular diseases or hypercholesterolaemia. If the consumption thereof is not completely to be banished, it is however recommended to limit it in favour of unsaturated fatty acids.

It therefore appears necessary to be able to propose oils with a concentration of polyunsaturated fatty acids, in particular omega-3 such as DHA and EPA, which have in addition a limited saturated fatty acid content.

Moreover, good supplementation with a substance does not depend solely on the quantity of this substance, but also the bioavailability thereof. Studies proved that the absorption of long-chain polyunsaturated fatty acids coming from fish oil in the form of so-called reconstituted triglycerides was superior to that of fatty acids in the form of natural triglycerides or in the form of ethyl esters (Schuchardt et al.; Prostaglandins, leukotrienes and essential fatty acids; 89 (2013) 1-8). Reconstituted triglycerides are obtained from natural triglycerides of oils by transesterification/re-esterification methods. In these methods, the fatty acids are transferred in the form of ethyl esters (fatty acid ethyl esters), or then undergo molecular distillation so as to concentrate the long-chain polyunsaturated fatty acid fraction. These fatty acids are next converted, enzymatically, in the form of glycerides, in particular triglycerides.

In addition, a study undertaken by Fumiaki et al. (Lymphatic absorption of docosahexaenoic acid given as monoglyceride, diglyceride, triglyceride and ethyl ester in rats; J. Nutr. Sci. Vitaminol; 48, 30-35, 2002) showed that the lymphatic dosage of DHA previously ingested in the form of mono- and diglycerides was superior to that obtained with DHA previously ingested in the form of triglycerides and ethyl esters. The good bioavailability of long-chain polyunsaturated fatty acids in the form of monoglycerides was also verified in another study (Valenzuleaa et al.). This study shows that supplementation with DHA monoglycerides makes it possible to find a DHA content in the plasma and red corpuscles higher than what is found when the DHA is supplied in the form of ethyl esters

(Effect of Supplementation with Docosahexaenoic Acid Ethyl Ester and sn-2 Docosahexaenyl Monoacylglyceride on Plasma and Erythrocyte Fatty Acids in Rats, Ann Nutr Metab, 2005; 49: 49-53).

It therefore also appears necessary to be able to offer oils with a high concentration of polyunsaturated fatty acids, in particular omega-3, which are essentially in the form of triglycerides, diglycerides and monoglycerides.

The present invention thus relates to a microorganism oil composition enriched with polyunsaturated fatty acids, which is characterised in that it has:
a saturated fatty acid content of less than or equal to 40 mg/g of composition,
an omega-3 polyunsaturated fatty acid content greater than or equal to 500 mg/g of composition,

and in that it comprises, with respect to the total quantity of monoglycerides, diglycerides, triglycerides and fatty acid ethyl esters:
a quantity of triglycerides below 70%,
a quantity of diglycerides of between 10 and 35%,
a quantity of monoglycerides of between 1 and 5%.

The composition according to the invention therefore has an excellent fatty acid profile with high omega-3 polyunsaturated fatty acid content and a very low saturated fatty acid content. It also has excellent bioavailability, favouring the most effective chemical forms.

Advantageously, the saturated fatty acid content of the composition according to the invention is less than or equal to 30 mg/g of composition, and preferentially less than or equal to 25 mg/g of composition.

The oil composition can be obtained from microalgae of the genus Thraustochytrium, Schizochytrium, Nannochloropsis, Isochrysis, Phaeodactylum, Nitzchia, Staurosira, Crypthecodinium or Ulkenia.

The microalgae of the genera Thraustochytrium and Schizochytrium will make it possible to obtain an oil composition enriched with eicosapentaenoic acid (EPA).

The microalgae of the genera Nannochloropsis, Isochrysis, Phaeodactylum or Nitzchia will make it possible to obtain an oil composition enriched with eicosapentaenoic acid (EP A).

Within the meaning of the invention, “enriched with polyunsaturated fatty acids” means a composition comprising, after implementation of adapted concentration methods, more than twice the quantity of polyunsaturated fatty acids that the composition had initially.

Preferentially, the composition comprises a quantity of triglycerides of between 40 and 67%, more preferentially between 55 and 65%, with respect to the total quantity of monoglycerides, diglycerides, triglycerides and fatty-acid ethyl esters.

Preferentially again, the composition comprises between 25 and 35% diglycerides with respect to the total quantity of monoglycerides, diglycerides, triglycerides and fatty-acid ethyl esters.

Preferentially again, the composition comprises between 1 and 2% monoglycerides with respect to the total quantity of monoglycerides, diglycerides, triglycerides and fatty-acid ethyl esters.

In the context of the invention, the quantity of ethyl esters is less than 2% with respect to the total quantity of monoglycerides, diglycerides, triglycerides and fatty-acid ethyl esters.

According to a first embodiment, the composition comprises a DHA content greater than or equal to 600 mg/g of composition, more preferentially greater than 700 mg/g of composition.

According to a second embodiment, the composition comprises an EPA content greater than or equal to 600 mg/g of composition, preferentially greater than 700 mg/g of composition.

According to a first embodiment of the invention, the composition comprises at least 4 mg/g of composition of omega-3 eicosatetraenoic acid, preferentially between 4 and 8 mg/g of composition.

If the polyunsaturated fatty acids belonging to the omega-3 family have been the subject of numerous studies and scientific publications for several years, the latter in reality relate only mainly to EPA and DHA. At the present time, the interest of the scientific community is turning towards other omegas-3, which probably have key and independent roles in numerous physiological mechanisms. This is for example the case with omega-3 eicosatetraenoic acid (ETA). This fatty acid was identified almost 20 years ago through the studies of Careaga and Sprecher (Metabolism of 8,11,14,17-eicosatetraenoic acid by human platelet lipoxygenase and cyclooxygenase. Biochimica et Biophysica Acta, Volume 920, p94-101.) and of Croset et al. (Inhibition of Prostaglandin H Synthase and Activation of 12-Lipoxygenase by 8,11,14,17-eicosatetraenoic Acid in Human Endothelial Cells and Platelets. Biochemical Pharmacology, Volume 57, p631-638). These studies revealed an anti-inflammatory effect of eicosatetraenoic acid, a reduction in the form of pro-inflammatory compounds and an inhibiting effect on platelet aggregation.

As a result eicosatetraenoic acid would be a good alternative to non-steroidal anti-inflammatory inhibiters such as aspirin or indometacin.

The composition according to the invention is therefore clearly advantageous since it offers a not insignificant quantity of omega-3 eicosatetraenoic acid.

According to the first embodiment of the invention also, the composition comprises an omega-6 docosapentaenoic acid (DPA) content of less than or equal to 140 mg/g of composition, preferentially between 70 and 140 mg/g of composition.

Another object of the invention is to propose a method for preparing a microorganism oil composition having the characteristics described above.

For this purpose, the method according to the invention comprises:

(i) a step of reaction between a microorganism oil comprising omega-3 polyunsaturated fatty acids in triglyceride form and an alcohol in the presence of a chemical or enzymatic catalyst,

(ii) a step of concentration with omega-3 polyunsaturated fatty acid by molecular distillation under high vacuum in a scraper film evaporator coupled with a rectification column comprising at least seven theoretical plates,

(iii) a step of restructuring monoglycerides, diglycerides and triglycerides of omega-3 polyunsaturated fatty acid in the presence of enzyme and glycerol,

(iv) a step of short-path molecular distillation under vacuum.

In natural oils, the omega-3 polyunsaturated fatty acids are essentially in the form of triglycerides, i.e. esterified on the glycerol skeleton. One method for concentrating these fatty acids then consists initially in releasing them from the glycerol.

The step (i) of reaction between the oil and an alcohol in the presence of a catalyst is a transesterification step that will make it possible to obtain fatty acids in an ethyl ester (EE) form.

Preferably, the transesterification reaction is performed with ethanol by way of alcohol and sodium ethylate by way of catalyst.

The oil/ethanol/catalyst weight ratio is preferentially 1:less than 0.5:less than 0.05.

This reaction is conducted at a temperature of between 40 and 120° C., preferentially between 40 and 60° C., for a time of between 1 and 12 h, preferentially between 1 and 2 h.

At the end of the reaction, more than 95% of the fatty acid is in the form of ethyl esters.

The fatty-acid ethyl esters formed can then be distilled by molecular distillation to collect therefrom the concentrated polyunsaturated fatty acid fraction of interest during step (ii).

Distillation under high vacuum enables the ethyl esters to be separated according to the volatility thereof. This depends on the molecular weight thereof and the length of the fatty acid chains.

Thus, for the purpose of concentrating the oil composition in terms of polyunsaturated fatty acids of interest such as DHA or EPA, this step will make it possible to eliminate to the maximum possible extent the fatty acids the chain of which comprises fewer than 20 carbon atoms.

Importantly, the molecular distillation is performed in a scraper film evaporator coupled to a rectification column comprising at least seven theoretical plates. Use of the rectification column makes it possible to reduce the quantity of saturated fatty acids in the distillation residue and to improve the separative ability.

Moreover, because of the high degree of polyunsaturation of the fatty acids of interest and therefore their great sensitivity to oxidation, distillation under high vacuum is necessary. The parameters applied must prevent the risk of isomerisation of the EPA or of the DHA.

The distillation parameters are therefore generally, in the context of the invention, as follows:

Distillation vacuum 0.01 to 0.20 mbar,

Temperature in the scraper film evaporator 190 to 240°,

Temperature in the column top 130 to 200° C.

At the end of this step, a raffinate rich in long-chain fatty acid esters and a distillate rich in short-chain fatty acid esters is obtained.

The fatty acid ethyl esters are next converted in a step (iii) of re-esterification in the form of triglycerides, monoglycerides and diglycerides, forms having better bioavailability as explained previously.

Preferentially, the enzyme used in this step is a lipase, advantageously a Candida antarctica lipase B.

This reaction is conducted at a temperature of between 40 and 60° C., for a time of between 15 and 30 h, preferentially between 20 and 25 h.

The step (iii) of restructuring of the monoglycerides, diglycerides and triglycerides is followed by a step (iv) of short-path molecular distillation under high vacuum to eliminate the residual ethyl esters and the odorous volatile compounds but also to inactive any residual potential enzymatic activity. This step makes it possible to concentrate further the composition of monoglycerides, diglycerides and triglycerides.

According to one embodiment, the method according to the invention also comprises the following subsequent steps of (v) deodorisation and/or (vi) addition of antioxidants.

The deodorisation step (v) is an optional step that takes place in the presence of steam. The implementation thereof follows the step (iv) of molecular distillation. The steam entrains molecules that were not eliminated at the step (iv) of molecular distillation. The degree of polyunsaturation of the oils obtained being very high, the use of a scraper film evaporator with injection of dry steam under vacuum of less than 1 mbar allows deodorisation with a short residence time of less than one minute. The oxidation, peroxide (IP) and anisidine (Ian) indices are also lowered by this method.

The step (vi) of adding antioxidants is a step that is also optional, the purpose of which is to improve the resistance of the composition to oxidation. Antioxidants such as ascorbyl palmitate, rosemary extract, phospholipids, tocopherol and any other antioxidant known to persons skilled in the art can be used.

The invention also concerns a food supplement or a pharmaceutical, nutraceutical or food composition, in particular a child food composition, comprising a composition as described previously.

A food supplement may be a capsule, a soft capsule, a tablet, a powder, a gel, a syrup or any other form known to persons skilled in the art.

A pharmaceutical, nutraceutical or food composition may be a solid or liquid composition or a gel, adapted to an adult, to a child or to a baby. Such a composition may comprise other compounds such as proteins and carbohydrates.

The invention will be understood better from the reading of the following examples.

### Example 1: Concentration of a Microalga Oil in Terms of DHA Mainly in the Form of Monoglycerides, Diglycerides and Triglycerides

This example illustrates the method according to the invention and is implemented using a raw oil produced by the Schizochytrium sp T18 microalgae strain sold by the company Mara Renewables Corporation.

The oil initially contains 329 mg/g of DHA. The objective here is at a minimum to double the DHA concentration.

Step (i): Transesterification

A transesterification reaction is performed on a biomass of 1800 kg of microalgae oil using 450 kg of ethanol and 21.6 kg of sodium ethylate, in a suitable reactor.

The reaction temperature is 50° C. and the reaction time is 1 h. At the end of the reaction, the excess ethanol is evaporated under vacuum, and then the mixture is cooled to a temperature of approximately 30° C. and then subjected to settling for 1 h. The light phase is recovered and then the glycerol is drained off. A second settling is performed for 30 sec. The glycerol and the residual monoglycerides are drained off.

Washing with acidic water is next performed by adding 17% of demineralised water containing 2.5% phosphoric acid (75%) under stirring for 20 sec. The mixture is settled for 20 sec and the aqueous phase is drained off. Drying under vacuum follows (pressure<90 mbar) at 60° C. for a time greater than 2 h.

At the end of this step the oil contains 329 m/g of DHA in the form of ethyl esters.

Step (ii): Concentration of DHA by Molecular Distillation

The oil is next conducted into a degasser and then passes through a scraper film evaporator. The vapours are next distilled through a rectification column that is coupled to the evaporator supplied by the company UIC GmbH. A reflux of the distillate, that is to say a reintroduction of the distillate into the column, can make it possible to increase the separative efficacy thereof. The column used contains approximately seven theoretical plates. The distillation residue is recovered and represents the fraction enriched in DHA.

The operational conditions are as follows: T° of the evaporator: 225° C.; vacuum of the rectification: 0.1 mbar; reflux level 75%, T ° (top of column): 195° C.

The following table 1 compares the fatty acid profile of the oil obtained after this step (ii) with the initial fatty acid profile before the first step (i). The quantities are expressed in mg of each fatty acid per g of oil.

TABLE 1

| | Fatty acid composition before | Fatty acid composition after |
|---|---|---|
| | step (i) | step (ii) |
| C4:0 | 1.867 | — |
| C6:0 | 1.808 | — |
| C12:0 | 7.542 | — |
| C14:0 | 89.582 | 4.428 |
| C15:0 | 2.478 | — |
| C16:0 | 153.76 | 10.206 |
| C16:1 | 69.696 | 5.611 |
| C18:0 | 6.133 | — |
| C18:1 n9 cis | 19.555 | 8.442 |
| C18:1 n7 cis | 89.271 | 17.745 |
| C18:2 n6 cis | 10.651 | 3.487 |
| C20:4 n3 | 3.055 | 5.572 |
| EPA | 11.294 | 18.856 |
| C22:5 n6 | 55.904 | 125.453 |
| DHA | 329.162 | 757.958 |

More than 97% of the DHA is preserved in the recovered residue. The quantity of DHA has changed from 329 mg/g of DHA in the form of ethyl esters to 758 mg/g. The operating conditions were adjusted with a view to preserving the DHA to the maximum extent and to make a C20 cut while best preserving the C20:4 n-3 ETA. The omega-3 ETA then changes from 3 to more than 5 mg/g. Under these operating conditions, the EPA is also concentrated but remains at relatively low values. The DPA n-6, very similar to DHA, is necessarily concentrated but however the concentrations achieved remain limited.

The quantity of saturated fatty acids in the residue is minimal. The C16:0 palmitic acid is for example almost eliminated from the residue. It should be noted that only 2.5% of its initial content is preserved.

Step (iii): Synthesis of Triglycerides, Diglycerides and Monoglycerides

The reaction takes place in a reactor in the presence of immobilised enzyme. It is a case of a lipase of the fraction B of Candida antarctica (marketed under the name Lipozym 435 by the company Novozym).

480 g of distillation residue containing approximately 758 mg/g of DHA, 33 g of glycerol and 20 g of enzyme is introduced into the reactor.

The reaction takes place under moderate stirring, at controlled temperature around 60° C., under vacuum with evaporation and condensation of the ethanol generated. The reaction time is 25 h.

The yield of the reaction is more than 95%.

At the end of this step, the oil has the following glyceride profile (Table 2):

TABLE 2

| Ethyl esters | Monoglycerides | Diglycerides | Triglycerides |
|---|---|---|---|
| 8.6% | 5.7% | 35.8% | 49.9% |

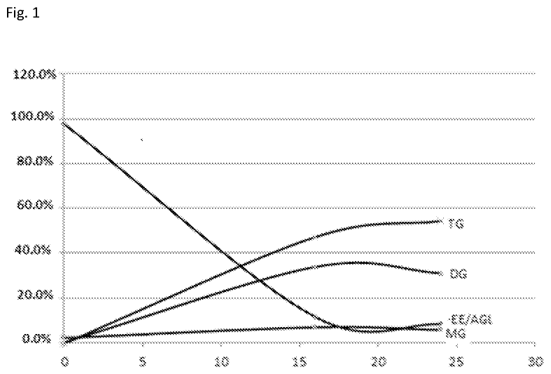

FIG. 1 illustrates the conversion kinetics of the DHA in the form of ethyl esters as mono-, di- and triglycerides over time.

Step (iv): Short-Path Molecular Distillation

After synthesis, the product is taken up to pass through a short-path still (sold by the company UIC GmbH) to eliminate the residual ethyl esters, and the odorous volatiles, and also to inactivate a potential residual enzymatic activity.

The conditions are a temperature of the walls of the evaporator of between 160 and 220° C. and a vacuum below 0.02 mbar. The vacuum is preferably 0.005 mbar to make it possible to reduce the distillation temperature.

At the end of this step, the oil has the profile indicated in Table 3:

TABLE 3

| Compounds | Units | Values (Example 1) |
|---|---|---|
| DHA | mg/g | 758 |
| Saturated fatty acids (SFA) | mg/g | 15 |
| Triglycerides (TG) | % | 63 |
| Diglycerides (DG) | % | 36 |
| Monoglycerides (MG) | % | 2 |
| Ethyl esters/free fatty acids (EE/FFA) | mg/g | 1.2 |
| EPA | mg/g | 20 |
| ETA n-3 | mg/g | 6 |
| DPA n-6 | mg/g | 105 |

Step (vi): Deodorising

The oil is conveyed into a scraper film evaporator into which dry steam is injected. The reaction takes place during a short residence time of at least one minute and under a vacuum of at least 1 mbar.

Step (vi): Addition of Antioxidants

The oil is made stable in the face of oxidation by adding antioxidant such as ascorbyl palmitate, rosemary extract, phospholipids, tocopherol or any other antioxidant known to a person skilled in the art.

1. A microorganism oil composition enriched with polyunsaturated fatty acids, wherein the microorganism oil composition comprises:
a saturated fatty acid content of less than or equal to 40 mg/g of composition,
an omega-3 polyunsaturated fatty acid content greater than or equal to 500 mg/g of composition,
and in that it comprises, with respect to the total quantity of monoglycerides, diglycerides, triglycerides and fatty acid ethyl esters:
a quantity of triglycerides of between 40 and 67%,
a quantity of diglycerides of between 10 and 35%,
a quantity of monoglycerides of between 1 and 5%.

2. The composition according to claim 1, wherein the saturated fatty acid content is less than or equal to 30 mg/g of composition.

3. The composition according to claim 1, further comprising a quantity of triglycerides of between 55 and 65%, with respect to the total quantity of monoglycerides, diglycerides, triglycerides and fatty-acid ethyl esters.

4. The composition according to claim 1, further comprising between 25 and 35% diglycerides with respect to the total quantity of monoglycerides, diglycerides, triglycerides and fatty-acid ethyl esters.

5. The composition according to claim 1, further comprising between 1 and 2% monoglycerides with respect to the total quantity of monoglycerides, diglycerides, triglycerides and fatty-acid ethyl esters.

6. The composition according to claim 1, further comprising a docosahexaenoic acid content greater than or equal to 600 mg/g of composition.

7. The composition according to claim 1, further comprising an eicosapentaenoic acid content greater than or equal to 600 mg/g of composition, composition.

8. The composition according to claim 1, wherein the microorganism oil composition-A comprises at least 4 mg/g of composition of omega-3 eicosatetraenoic acid.

9. The composition according to claim 1, further comprising an omega-6 docosapentaenoic acid content of less than or equal to 140 mg/g of composition.

10. The composition according to claim 1, wherein the microorganism oil composition is in the form of a food supplement or a pharmaceutical, nutraceutical or food composition, especially for children.

11. A method for preparing a microorganism oil composition enriched with omega-3 polyunsaturated fatty acids, wherein the microorganism oil composition comprises:
(i) a step of reaction between a microorganism oil comprising omega-3 polyunsaturated fatty acids in triglyceride form and an alcohol in the presence of a chemical or enzymatic catalyst,
(ii) a step of concentration with omega-3 polyunsaturated fatty acids by molecular distillation under high vacuum in a scraper film evaporator coupled with a rectification column comprising at least seven theoretical plates,
(iii) a step of restructuring monoglycerides, diglycerides and triglycerides of omega-3 polyunsaturated fatty acid in the presence of enzyme and glycerol, and
(iv) a step of short-path molecular distillation under vacuum.

12. The method according to claim 11, further comprising the following subsequent steps of (v) deodorising and/or (vi) adding antioxidant.
